(19) United States
(12) Patent Application Publication
(10) Pub. No.: US 2012/0116835 A1
(43) Pub. Date: May 10, 2012

(54) HYBRID TASK BOARD AND CRITICAL PATH METHOD BASED PROJECT MANAGEMENT APPLICATION INTERFACE

(75) Inventors: Alexander Pope, Seattle, WA (US); Jonathan Kaufthal, Seattle, WA (US)

(73) Assignee: Microsoft Corporation, Redmond, WA (US)

(21) Appl. No.: 12/943,511

(22) Filed: Nov. 10, 2010

(51) Int. Cl. G06Q 10/00

(52) U.S. Cl. 705/7.26

(57) ABSTRACT

Seamless interaction between a task board and an underlying Critical Path Method (CPM) based project management application is provided, where users are enabled to move tasks on a task board user interface across columns or summary task (“story”) rows. Upon detecting a move of a task, a task board application (or its parent project management application) updates a project hierarchy of tasks reflecting the new grouping if the move is across rows such that critical path and other computations for the overall project can be updated by the project management application. If the move is across columns indicating a change of task property, relevant properties associated with the task (and/or its parent task(s)) are updated and provided to the project management application for re-computation of appropriate aspects of the project.

### BACKGROUND

Many operations of business or non-business organizations may be defined and structured as projects. Within a structured project, designated people may develop plans, assign resources to tasks, track progress, manage budgets, and analyze progress/workloads. Project management applications enable users to create critical path schedules and resource allocations in a manual, automated, or semi-automated manner. Project applications using Critical Path Method (CPM) construct a model of a project that includes a list of activities required to complete the project, a time (or duration) for each activity to be completed, and any dependencies between the activities. Based these parameters, the application computes a longest path of planned activities to the end of the project, and the earliest and latest that each activity can start and finish without making the project longer, thereby determining which activities are critical (i.e., on the longest path) and which can be delayed without making the project longer.

Schedules, resource allocations, and other aspects of the projects may be visualized in different ways such as Gantt charts. Some project management applications also provide additional views such as calendars, tables, etc. Typical project management applications are relatively complex programs that can interact with other applications like Enterprise Resource Planning (ERP) applications to integrate project management with other aspects of the organizations such as inventory, marketing, customer service, and similar ones. Thus, project management applications typically store and process a spectrum of information at varying depths associated with projects, participants, resources, and other aspects of projects.

Task boards may be viewed as a simple version of project management tools. A typical task board includes a listing of tasks in a hierarchically structured manner and their progress status. A variety of additional features and complexities may be added to task boards, but their basic functionality is to provide an overview of relevant tasks and their properties to a user. Because a majority of task board applications are designed for simplicity in visualizing task and status data, their interactivity with other programs such as project management applications and their interactivity with users regarding available features and capabilities are typically limited.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to enabling seamless interaction between a task board and an underlying CPM based project management application. According to some embodiments, users may be enabled to move tasks on a task board user interface across property columns or summary task (“story”) rows. Upon detecting a move of a task, a task board application (or its parent project management application) may update a project hierarchy of tasks reflecting the new grouping if the move is across rows such that critical path and other computations for the overall project may be updated by the project management application. If the move is across columns indicating a change of a task property, relevant properties associated with the task (and/or its parent task(s)) may be updated and provided to the project management application for re-computation of appropriate aspects of the project. According to other embodiments, items may be moved and hierarchies updated across columns and rows, or multiple items moved at the same time.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating example CPM project based task board implementations;

FIG. 2 illustrates conceptually an effect of task move on a task board on underlying projects;

FIG. 3 illustrates an example task board user interface where tasks may be moved across columns or rows according to some embodiments causing respective changes in underlying project(s);

FIG. 4 is a networked environment, where a system according to embodiments may be implemented;

FIG. 5 is a block diagram of an example computing operating environment, where embodiments may be implemented; and

FIG. 6 illustrates a logic flow diagram for a process of providing interactive changes on a hybrid task board with an underlying CPM project management application according to embodiments.

### DETAILED DESCRIPTION

As briefly described above, users may be enabled to move tasks on a task board user interface across property columns or summary task (“story”) rows. Upon detecting a move of a task, a task board application (or its parent project management application) may update a project hierarchy of tasks reflecting the new grouping if the move is across rows such that computations for critical path and any other dependent/related tasks even if not on the critical path may be updated by the project management application. If the move is across columns indicating a change of task property, relevant properties associated with the task/its parent task/its dependent children tasks may be updated and provided to the project management application for re-computation of appropriate aspects of the project. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable storage media.

Throughout this specification, the term “platform” may be a combination of software and hardware components for project management and task board systems. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

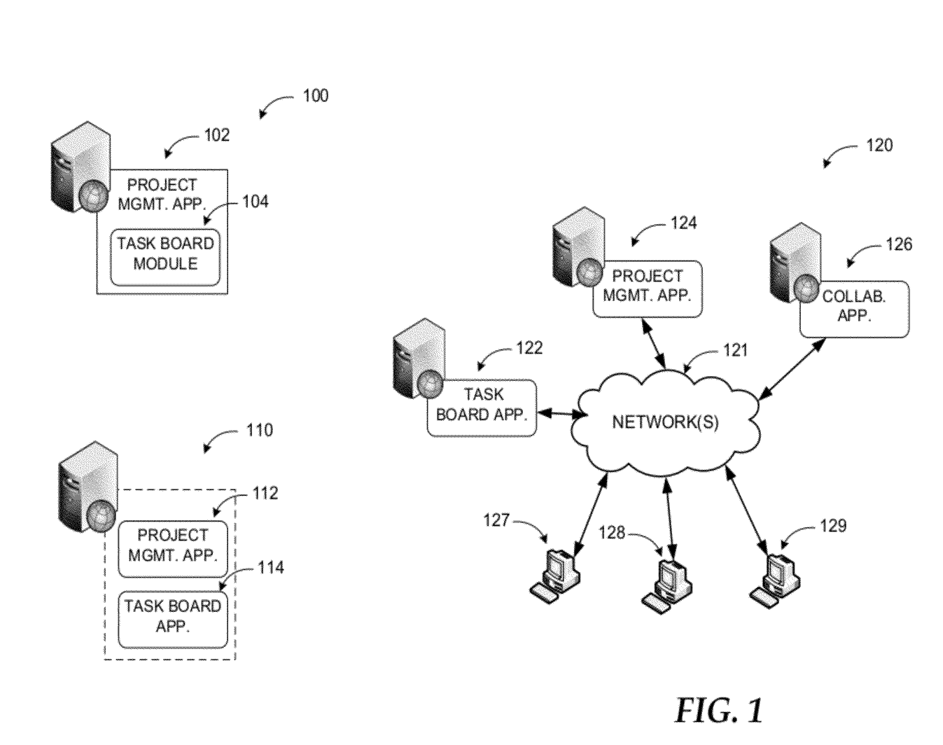

Referring to FIG. 1, a conceptual diagram 100 of example CPM project based task board implementations, is illustrated. A project management application may enable users to create critical path schedules and resource allocations in a manual, automated, or semi-automated manner. Such an application may compile data, analyze scenarios, and visualize various aspects of projects such as schedules, resource allocations, and similar ones using visual tools like Gantt charts, calendars, tables, and comparable ones.

A project can have several, parallel, near critical paths. An additional parallel path through the network with the total durations shorter than the critical path is called a sub-critical or non-critical path. A CPM based project management application may include resources related to each activity, through processes called activity-based resource assignments and resource leveling. A resource-leveled schedule may include delays due to unavailability of a resource at the required time. Because project schedules may change on a regular basis, a CPM based project management application may continuously monitor the schedule, enable a project manager to track the critical activities, and provide alerts associated with critical and non-critical activities. Moreover, the application may incorporate concepts of stochastic predictions, using Program Evaluation and Review Technique (PERT), event chain methodology, and similar approaches.

A task board application may visualize tasks employing a grid of columns reflecting the state of a given task (e.g., not started, in progress, ready for testing signoff, completed, etc.) and rows representing aggregations of tasks (summary tasks, or “stories”), while the tasks themselves may be represented by graphical, textual, or combination of graphical and textual objects on the grid. Various graphical, textual, coloring, shading, and similar schemes may be employed to emphasize different aspects of displayed tasks, their properties, and other properties.

A project management and task board system according to embodiments may be configured in a variety of ways. For example, a task board module 104 executed in conjunction with (as an integrated or add-on module) project management application 102 may provide task board view(s) of tasks associated with projects managed by the project management application 102, as shown in example scenario of diagram 100. According to another example scenario 110, the project management application 112 and task board application 114 may be distinct applications installed and executed locally or remotely providing their respective services while interacting to maintain a connection between the tasks, their properties, their relationships, and the underlying project hierarchy.

According to yet another example scenario 120, task board application 122 and project management application 124 may be part of a distributed (or centralized) system and provide one or more project management related services for users accessing the services through client devices 127, 128, or 129 via network(s) 121. While the task board and project management services may be individual services, they may also be provided as an integrated service through a collaboration application 126 as a hosted service according to further embodiments.

Local access may be provided by locally installed rich clients (a local version of the project management or task board applications) or generic applications like browsers. Client devices 127 through 129 may be any computing device including, but not limited to, desktop computers, laptop computers, handheld computers, mobile computers, vehicle-mount computers, smart phones, and similar devices. According to further embodiments, one or both applications may be provided as part of a larger service, for example, a business tools service. Embodiments are not limited to these configurations, however. Other forms and configurations of providing a CPM project management application based hybrid task board interface may be implemented using the principles described herein.

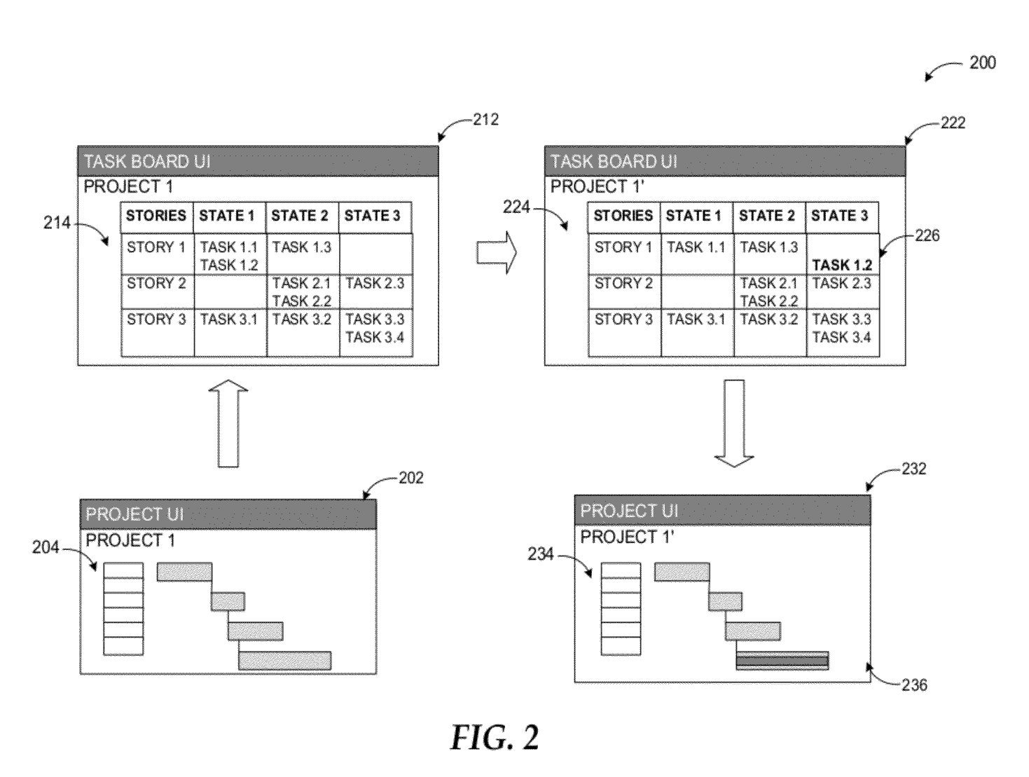

FIG. 2 illustrates conceptually an effect of task move on a task board on underlying projects. A task board application according to embodiments combines a task board with traditional critical-path method scheduling system data, enabling the same data to be represented and updated in either user interface. Thus, a traditional project outline (i.e., set of parent and sub-tasks in a hierarchy) may be transformed into a horizontal grouping of summary tasks (or “stories”) and sub-tasks. Furthermore, conventional and intrinsic or custom project management fields such as percent complete may be used for automatic placement of specific tasks into appropriate columns on the task board. By incorporating a task board into a conventional project management application, users may be enabled to interact with the task board while maintaining a consistent and accurate state for the project management application. Thus, user initiated changes on the task board may be propagated properly to the underlying project management application such that computations, analyses, and visualizations for the project(s) may be updated accordingly.

As discussed above, a task board may be provided by an independent application or a module within a project application. Diagram 200 illustrates a conceptual project view 204 within a project management application user interface 202 (e.g., a Gantt chart). Task board 214 within task board application 212's user interface reflects a task board view of selected (or all) tasks from the same project displayed by project management user interface 202. the tasks are displayed in grid format on task board 214 with rows corresponding to summary tasks (or stories) and columns representing states of tasks (e.g., “To Do”, “Not Started”, “In Progress”, “Completed”, “Abandoned”, etc.). The tasks themselves may be represented as graphical objects (e.g., icons, boxes, circles, etc.), textual objects (e.g., simple text), or combinations of those. A variety of textual, graphical, coloring, shading schemes may be employed to emphasize different aspects of the tasks. Furthermore, the objects representing the tasks may be actionable providing links to operations associated with the tasks such as modification of task properties, viewing parameters, and so on.

In a system according to embodiments, a user may be enabled to modify the task board by moving one or more tasks across columns and/or rows as illustrated by the modified task board 224 on task board application user interface 222. The task 226 identified as “Task 1.2” has been moved from “State 1” column to “State 3” column. For example, “State 1” may be “Not Started” column and “State 3” may be “Completed” column indicating that the moved task has been completed.

A task in a project management application may be associated with several fields such as Name, Start, Finish, Percent Complete, and similar ones, where information about the task is stored. Project management applications often use these fields to display interesting views about data, for example, a task in a Gantt chart may have an indicator that uses the Percent Complete field to draw a certain way.

A task board according to embodiments works with an underlying project management application packages such as Microsoft Project® by Microsoft Corporation of Redmond, Wash. by reading and writing to the same underlying data structures. For example, when a task is moved to a new column on the task board, the Percent Complete field in the project management application may be updated based on the following mapping: “Not Started” 0%; “In Progress” 50%; “Completed” 100%. Thus, when a project manager views their project plan they are able to see meaningful data that was obtained from a non-traditional source such as the task board. Likewise, when a task is moved from one column to another, the underlying task order may be rearranged and the change reflected in the project management views such as Gantt charts. The changes from task board 224 are conceptually represented in the project view 234 of project management application user interface 232 with the addition of the darker project element 236 to the Gantt chart.

The translation of changes on the task board to updated field values in the project management application may be performed in a variety of ways. As discussed above, a mapping strategy may be applied coupling different property columns to corresponding field values. The transformation may also be performed employing one or more rules. For example, a rule for placing tasks on the task board may indicate “tasks with zero percent complete and starting less than today are to be placed in a column titled To Do.” An algorithm facilitating the reverse transformation may evaluate a moved task in “To Do” column compare the date and set its percent complete field to zero based on the rule.

The specification of project field values based on new property columns or rows for moved tasks may be determined automatically based on mapping definitions, a default selection among available options, user selection of one or more predefined options, or user definition for specific fields. While the transformation of task changes on the task board to project information may be completely automatic according to some embodiments, a portion or all of the transformation related operations may also be performed manually according to other embodiments.

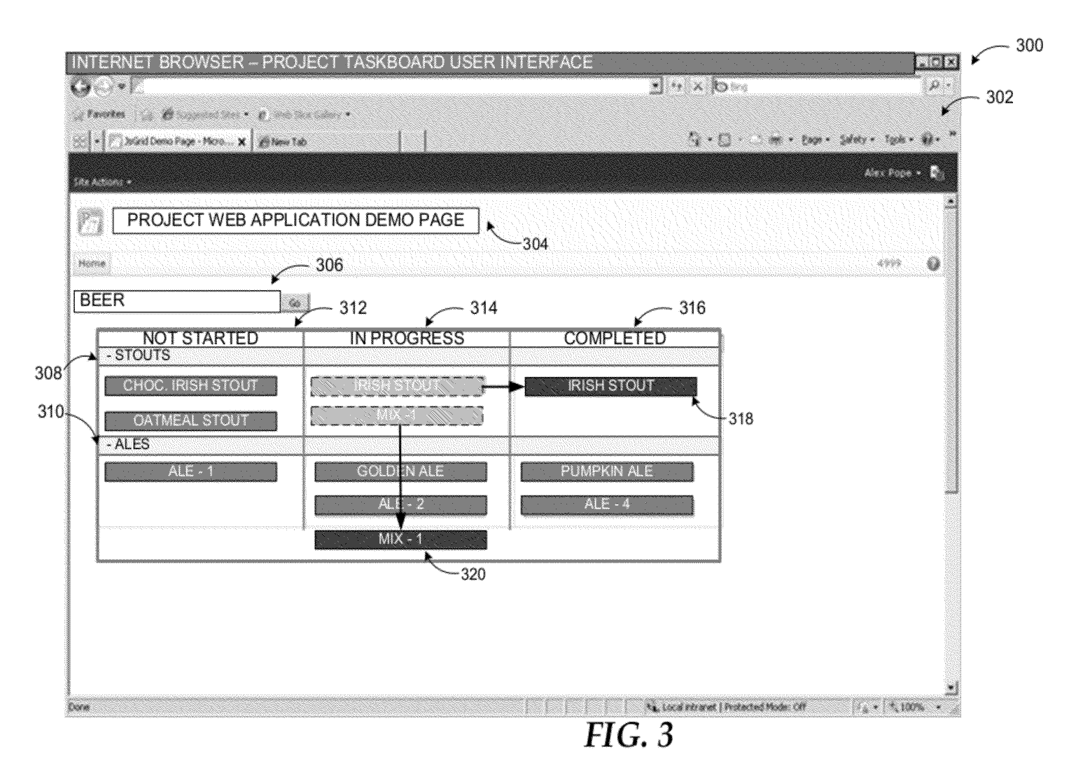

FIG. 3 illustrates an example task board user interface where tasks may be moved across columns or rows according to some embodiments causing respective changes in underlying project(s). As discussed previously, a task board application may be a separate application executed locally or as a hosted service, which is accessed through a generic client application such as a browser. The example task board user interface is presented through browser 300.

Browser 300 includes conventional browser controls 302 (graphical and/or textual control elements). The displayed web page includes a title 304 identifying the task board. The example task board displays the stories or summary tasks within first property column 312 “Not Started.” The project associated with the task board is identified in project box 306, which may be a selectable drop-down menu style box or a textual entry box to enable users to select different projects. Summary tasks 308 and 310 are listed in the first property column 312 hierarchically distinguished from the tasks (or sub-tasks) in the same column. Other tasks for each summary task are displayed in their respective columns 314 and 316 following the same hierarchical tree scheme.

The tasks on browser 300 are displayed using graphical objects with textual identification. A coloring or shading scheme may be employed to further identify a property of each task (e.g., a sub-property such as percentage for “In Progress” tasks). Some or all of the displayed elements may be actionable providing links to controls associated with setting or modifying parameters associated with the tasks or modifying view settings. Additional actions that may be initiated through the objects representing tasks may include, but are not limited to, editing, copying, scheduling, and comparable ones.

According to an example scenario, a user may be enabled to move task 318 from property column 314 to property column 316, effectively changing the task's property from “In Progress” to “Completed.” The task board application presenting the task board may update project field values such as a percent complete field to 100% enabling the underlying project management application to update the overall project status, resource allocations, critical path analyses, and available views. According to another example, the user may move task 320 from summary task 308 to summary task 310. The move may be reflected in a reordering of project hierarchies, resources, critical path calculations, etc. for the affected tasks in the project management application.

Users may be enabled to move tasks through a click and drag operation using an input device such as a mouse, through a user interface control element on the browser page associated with modifying task properties, through a drop-down or hover-on style control menu, or comparable controls (e.g. touch or keyboard based interactions). For example, controls for modifying task position may be activated by right-clicking or double-clicking on each task. In addition to modifying task positions, the controls may be used to present detailed data such as schedule, resources, designated person, or other project management views associated with the respective tasks.

The example applications, components, modules, data types, user interface elements, and interactions discussed in FIG. 2 and FIG. 3 are for illustration purposes only and do not constitute a limitation on embodiments. A hybrid task board interface based on CPM project management may be implemented with other components, modules, data types, and configurations using the principles described herein.

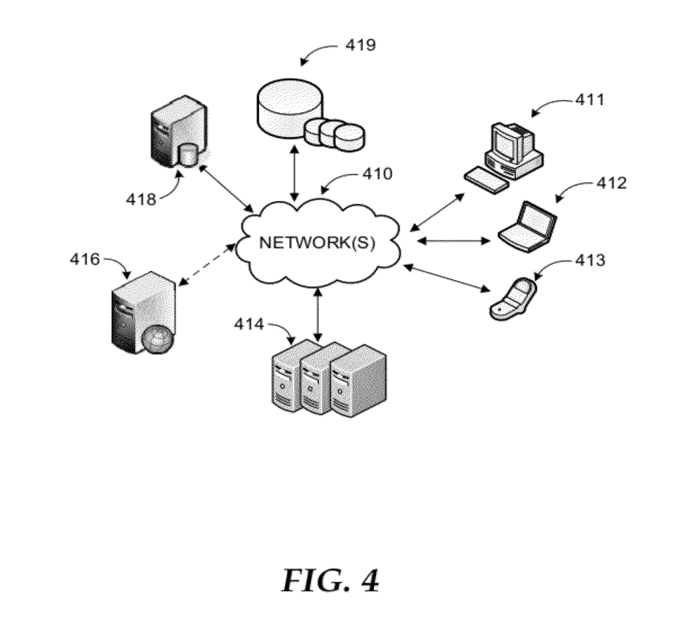

FIG. 4 is an example networked environment, where embodiments may be implemented. A platform providing task board and/or project management services may be implemented via software executed over one or more servers 414 or a single server (e.g. web server) 416 such as a hosted service. Alternatively, a task board application may be executed on server 416 and generate task board(s) based on project management data provided by a project management service executed on servers 414. The platform(s) may communicate with client applications on individual computing devices such as a smart phone 413, a laptop computer 412, or desktop computer 411 (client devices') through network(s) 410.

The task board application may visualize and track tasks enabling users to move tasks across columns and rows indicating property changes and regroupings, respectively. Upon detecting a move of a task across columns indicating a change of task property, the task board application may update relevant properties associated with the task/its parent task/its dependent children tasks and provide them to the project management application for re-computation of appropriate aspects of the project. Upon detecting a move across rows, the task board application may update a project hierarchy of tasks reflecting the new grouping such that critical path and other computations for the overall project may be updated by the project management application. Data associated with the project management and/or task board operations may be stored directly or through database server 418 at data stores 419.

Network(s) 410 may comprise any topology of servers, clients, Internet service providers, and communication media. A system according to embodiments may have a static or dynamic topology. Network(s) 410 may include secure networks such as an enterprise network, an unsecure network such as a wireless open network, or the Internet. Network(s) 410 may also coordinate communication over other networks such as Public Switched Telephone Network (PSTN) or cellular networks. Furthermore, network(s) 410 may include short range wireless networks such as Bluetooth or similar ones. Network(s) 410 provide communication between the nodes described herein. By way of example, and not limitation, network(s) 410 may include wireless media such as acoustic, RF, infrared and other wireless media.

Many other configurations of computing devices, applications, data sources, and data distribution systems may be employed to implement a hybrid task board and critical path method project system. Furthermore, the networked environments discussed in FIG. 4 are for illustration purposes only. Embodiments are not limited to the example applications, modules, or processes.

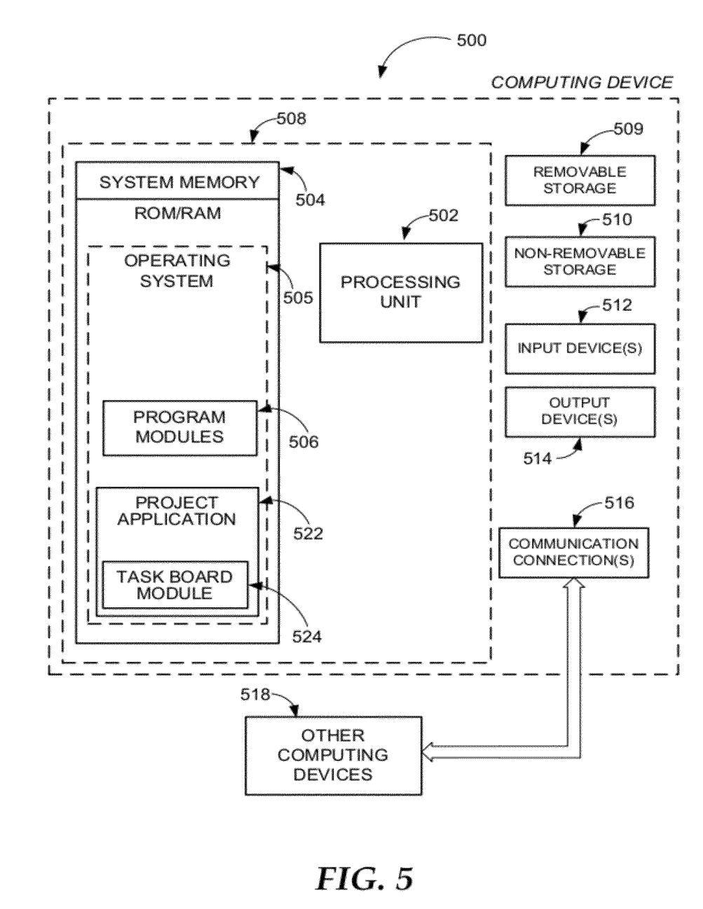

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may be a server or other computing device executing a project management and/or task board application and include at least one processing unit 502 and system memory 504. Processing unit 502 may have its own cache memory or use a dedicated portion of system memory 504 as cache. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the platform, such as the WINDOWS° operating systems from MICROSOFT CORPORATION of Redmond, Wash. The system memory 504 may also include one or more software applications such as program modules 506, project management application 522, and task board module 524.

Project management application 522 may provide CPM based project management services enabling designated people to develop plans, assign resources to tasks, track progress, manage budgets, analyze progress/workloads, and so on. Task board module 524 may generate, update, and display a task board based on project data from the project management application 522. Task board module 524 may further update project management application specific attributes of tasks upon detecting changes of property or change of grouping among the tasks by user action as discussed previously. Task board module 524 may be an integrated part of project management application 522, a separate application executed on the same computing device, or a separate application executed on a different computing device. Project management application 522 and task board module 524 may also be locally installed applications, distributed services, centralized services, or combinations of those. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wireless network in a distributed computing environment, a satellite link, a cellular link, and comparable mechanisms. Other devices 518 may include computer device(s) that provide data storage services, consume data, and comparable devices. Communication connection(s) 516 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

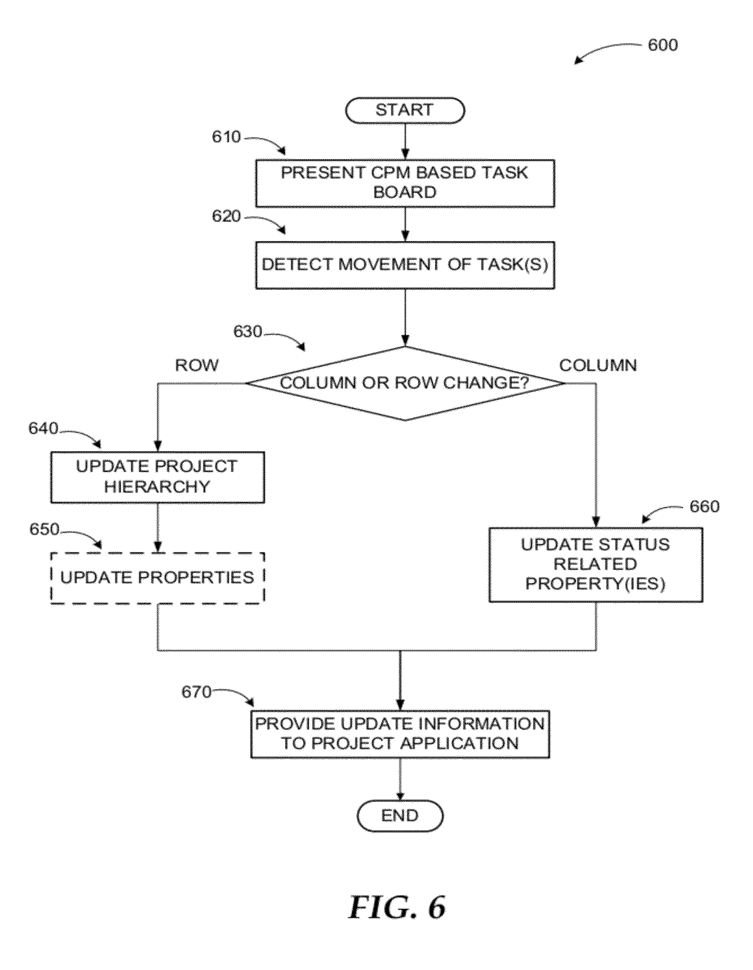

FIG. 6 illustrates a logic flow diagram for process 600 of providing interactive changes on a hybrid task board with an underlying CPM project management application according to embodiments. Process 600 may be implemented on a server or other computing device.

Process 600 begins with operation 610, where a CPM based project related task board is presented. The task board may be displayed in grid form with rows representing summary tasks and columns representing properties, where the tasks associated with each summary task are placed at intersections of appropriate rows and columns. At operation 620, a task movement may be detected. Users may be enabled to move tasks by a click and drag operation, through a property selection, or comparable user interface actions.

At decision operation 630, a determination may be made whether the move is a column change and/or a row change (e.g. a diagonal drag). If the move is a column change, it indicates a property change for the moved task(s). Thus, related properties (e.g., start/finish dates/times, duration, related task properties, etc.) may be updated at operation 660. If the move is a row change, it indicates a regrouping of tasks (i.e., the moved task being associated with a new summary task). In that case, the project hierarchy associated with the moved task may be updated at operation 640. Optionally, properties such as those listed above may also be updated at operation 650 (e.g., if the regrouping affects durations of individual tasks or a summary task). The updates from operations 660 and 650 may be provided to an underlying project management application at operation 670 such that appropriate aspects of the project can be re-computed, analyses updated, and visualizations modified.

The operations included in process 600 are for illustration purposes. A CPM based project related hybrid task board interface according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device for interactive management of tasks on a hybrid task board and an underlying project management application, the method comprising:
presenting a hybrid task board and Critical Path Method (CPM) based project application user interface;
enabling a user to modify at least one of a task and a hierarchical relationship of a task through the user interface;
in response to detecting a modification of a task performing at least one from a set of:
updating at least one related property of the task in the underlying project management application if the modification is associated with the task; and
updating a project hierarchy in the underlying project management application if the modification is associated with the hierarchical relationship of the task.

2. The method of claim 1, wherein the tasks are presented on the task board in a grid format with columns representing properties and rows representing summary tasks to which respective tasks are aggregated.

3. The method of claim 2, wherein enabling the user to modify the task includes enabling the user to move the task across columns.

4. The method of claim 2, wherein enabling the user to modify the hierarchical relationship of a task includes enabling the user to move the task across rows.

5. The method of claim 1, wherein each task is represented on the task board by one of: a graphical object, a textual object, and a combination of a graphical and textual object.

6. The method of claim 5, further comprising:
enabling the user to modify the task by one of: a click and drag operation, a right click, a double click, activation of a user interface control element, a drop-down menu selection, and a hover-on menu selection associated with each object representing a task.

7. The method of claim 5, wherein the objects representing the tasks are actionable objects providing a link to at least one from a set of: a data entry operation, an analysis operation, a computation operation, an edit operation, a scheduling operation, a copy operation, and a visualization operation.

8. The method of claim 1, wherein updating the at least one related property comprises:
modifying a task completion field value such that the underlying project management application is enabled to update at least one from a set of: a task property, an overall project status, a resource allocation, a critical path analysis, and an available project view.

9. The method of claim 1, wherein updating the task hierarchy in the underlying project management application comprises:
modifying at least one from a set of: a reordering of task hierarchies, resources, and critical path calculations for affected tasks in the project management application.

10. A computing device facilitating interactive management of tasks on a hybrid task board and an underlying project management application, the computing device comprising:
a memory;
a processor coupled to the memory, the processor executing a hybrid task board and Critical Path Method (CPM) based project application, the application performing actions including:
present the tasks on a task board based on a CPM based project employing a grid format with columns representing properties and rows representing summary tasks to which respective tasks are aggregated;
enable a user to modify at least one of a task and a hierarchical relationship of a task by moving the task across columns and rows, respectively;
in response to a move of a task across columns, update at least one related property of the task in the underlying project application; and
in response to a move of a task across rows, update a task hierarchy in the underlying project application.

11. The computing device of claim 10, wherein the at least one related property of the task is updated in the underlying project application automatically based on a mapping definition.

12. The computing device of claim 11, wherein the at least one related property of the task is further updated in the underlying project application based on at least one from a set of: a user selection of one or more predefined options, one or more rules, and a user specified definition.

13. The computing device of claim 11, wherein the grid format representation of the task board includes a single row associated with a flat project.

14. The computing device of claim 10, wherein the mapping definition specifies a task property field value in the underlying project application corresponding to each column on the task board.

15. The computing device of claim 10, wherein the task hierarchy in the underlying project management application is updated based on a rearrangement of tasks and summary tasks affected by the move across the rows and update of at least one property associated with the affected tasks and summary tasks.

16. The computing device of claim 10, wherein the underlying project application is configured to perform at least one from a set of: compile data, analyze scenarios, adjust schedules, modify resource allocations, and visualize the project in response to the modification of the task.

17. The computing device of claim 10, wherein the application is executed as one of: a centralized hosted service, a distributed hosted service, and a locally installed application.

18. A computer-readable storage medium with instructions stored thereon for interactive management of tasks on a hybrid task board and an underlying project management application, the instructions comprising:
presenting a hybrid task board and Critical Path Method (CPM) based project application user interface; and
enabling a user to interact with the task board while maintaining consistency and accuracy of a state of a project associated with the tasks on the presented task board through the underlying project application by:
propagating user initiated changes on the task board to the underlying project application such that computations, analyses, and visualizations for the project associated with the tasks on the presented task board.

19. The computer-readable storage medium of claim 18, wherein the tasks are displayed as actionable objects on the task board providing links for modification of task properties employing at least one from a set of: a graphical scheme, a textual scheme, a shading scheme, and a coloring scheme.

20. The computer-readable storage medium of claim 19, wherein the user initiated changes are propagated by:
updating a task completion field value at the underlying project application in response to a move of a task across columns on the task board; and
reordering a task hierarchy within the project associated with the tasks in response to the task being moved across rows on the task board.
